(19) United States
(12) Patent Application Publication
(10) Pub. No.: US 2018/0097412 A1
(43) Pub. Date: Apr. 5, 2018

(54) PERMANENT MAGNET MOTOR ROTOR AND PERMANENT MAGNET SYNCHRONOUS MOTOR

(71) Applicant: GREE GREEN REFRIGERATION TECHNOLOGY CENTER CO., LTD OF ZHUHAI, Zhuhai (CN)

(72) Inventors: Yong Xiao, Zhuhai (CN); Yusheng Hu, Zhuhai (CN); Bin Chen, Zhuhai (CN)

(73) Assignee: GREE GREEN REFRIGERATION TECHNOLOGY CENTER CO., LTD OF ZHUHAI, Zhuhai (CN)

(21) Appl. No.: 15/821,450

(22) Filed: Nov. 22, 2017

Related U.S. Application Data
(63) Continuation of application No. PCT/CN2016/083586, filed on May 27, 2016.

(30) Foreign Application Priority Data
May 29, 2015 (CN) 201510287956.9

(51) Int. Cl. H02K 1/27

(52) U.S. Cl. CPC H02K 1/2773; H02K 2201/00

(57) ABSTRACT

Disclosed are a permanent magnet motor rotor (110) and a permanent magnet synchronous motor (100). The permanent magnet motor rotor (110) comprises: a rotor core (111); tangentially magnetized main-pole permanent magnets (112), the main-pole permanent magnets (112) being disposed in a radial direction of the rotor core (111), the main-pole permanent magnets (112) being uniformly arranged in a circumferential direction of the rotor core (111), and the closest surfaces of any two adjacent main-pole permanent magnets (112) having same magnetic poles; and an auxiliary permanent magnet (113) being disposed in the radial direction of the rotor core (111), the auxiliary permanent magnet (113) being located between any two adjacent main-pole permanent magnets (112), so as to raise the operating point of the main-pole permanent magnet, thereby achieving the purpose that the demagnetization resistance capacity of the main-pole permanent magnet is improved, and the demagnetization risk is reduced.

### CROSS-REFERENCES TO RELATED APPLICATIONS

This application is a continuation of International Patent Application PCT/CN2016/083586, with an international filing date of May 27, 2016, which claims the benefit of Chinese Patent Application No. 201510287956.9, filed May 29, 2015, entitled “Permanent Magnet Motor Rotor and Permanent Magnet Synchronous Motor,” the entire disclosures of which are hereby incorporated by reference herein.

### TECHNICAL FIELD

The present disclosure relates to a motor device, and more particularly, to a tangentially magnetized permanent magnet motor rotor, and a permanent magnet synchronous motor having the permanent magnet motor rotor.

### BACKGROUND

The motor with tangentially magnetized permanent magnets provides a magnetic congregate effect, as compared with the magnetic motor with radially magnetized permanent magnets, a higher air-gap magnetic flux density is generated, thereby the motor with tangentially magnetized permanent magnets has a higher ratio of the torque to the current and a higher ratio of the torque to the volume. Therefore, the motor with tangentially magnetized permanent magnets has been more and more used in applications such as the servo system, electric traction, office automation and domestic appliances.

At present, both surfaces of a single permanent magnet embedded in the tangentially magnetized permanent magnet motor are configured to provide an air-gap magnetic flux simultaneously, and the magnetic circuit has a parallel structure, which leads to a lower operating point as compared with radially magnetized permanent magnet motor, and may be prone to decrease the efficiency of the tangentially magnetized permanent magnet motor. Even more, there is a risk of demagnetization of the tangentially magnetized permanent magnet motor under a rugged environment, which may result in that the tangentially magnetized permanent magnet motor is unable to operate.

### SUMMARY

In view of this, in order to overcome the problem of the lower working point and higher risk of demagnetization of the main-pole permanent magnet of the tangentially magnetized permanent magnet, it is necessary to provide a permanent magnet motor rotor and a permanent magnet synchronous motor having the permanent magnet motor rotor, so as to raise the operating point and to improve the demagnetization resistance capacity of the main-pole permanent magnet.

The above-mentioned object is accomplished with the following technical solutions:

A permanent magnet motor rotor comprises:

a rotor core;

tangentially magnetized main-pole permanent magnets, the main-pole permanent magnets being disposed in a radial direction of the rotor core, the number of the main-pole permanent magnets being equal to the number of poles of a permanent magnet synchronous motor, the main-pole permanent magnets being uniformly arranged in a circumferential direction of the rotor core, and the closest surfaces of any two adjacent main-pole permanent magnets having same magnetic pole; and

a tangentially magnetized auxiliary permanent magnet, the auxiliary permanent magnet being disposed in the radial direction of the rotor core, and the auxiliary permanent magnet being located between any two adjacent main-pole permanent magnets.

In one embodiment, the auxiliary permanent magnet is located at a symmetrical centerline between any two adjacent main-pole permanent magnets.

In one embodiment, the auxiliary permanent magnet is located at a position offset from a symmetrical centerline between any two main-pole permanent magnets, and the auxiliary permanent magnet is offset toward an adjacent main-pole permanent magnet having an opposite magnetic pole from that of the auxiliary permanent magnet.

In one embodiment, the coercivity of the auxiliary permanent magnet is less than the coercivity of the main-pole permanent magnet.

In one embodiment, the width of the auxiliary permanent magnet in a circumferential direction of the rotor core is less than the width of the main-pole permanent magnet in a circumferential direction of the rotor core.

In one embodiment, the length of the auxiliary permanent magnet in a radial direction of the rotor core is less than the length of the main-pole permanent magnet in a radial direction of the rotor core.

In one embodiment, the number of the main-pole permanent magnets is larger than or equal to four.

In one embodiment, any pair of adjacent main-pole permanent magnet and auxiliary permanent magnet are arranged in parallel, and the surface of the main-pole permanent magnet is attached to the surface of the auxiliary permanent magnet having an opposite magnetic pole from that of the main-pole permanent magnet.

In one embodiment, any pair of adjacent main-pole permanent magnet and the auxiliary permanent magnet are integrated.

Also a permanent magnet synchronous motor is provided, comprising a stator and a rotor, the stator being disposed outside the rotor, wherein, the rotor is the permanent magnet motor rotor as described in any one of the aforementioned embodiments.

The beneficial effects of the present disclosure are as follows:

The permanent magnet motor rotor and the permanent magnet synchronous motor of the present disclosure have a simple and reasonable structure, by arranging an auxiliary permanent magnet between any two adjacent main-pole permanent magnets, a part of the magnetic lines of the main-pole permanent magnet connect with the magnetic lines of the auxiliary permanent magnet in series, and then enter into the air-gap, the operating point of the main-pole permanent magnet is remarkably raised, the output torque of the permanent magnet synchronous motor is improved. Meanwhile, because of the increase of the operating point of the main-pole permanent magnet, the demagnetization resistance capacity of the main-pole permanent magnet is improved, and the demagnetization risk is reduced.

### BRIEF DESCRIPTION OF DRAWINGS

FIG. 1 is a structural schematic view illustrating a permanent magnet synchronous motor according to one embodiment of the present invention;

FIG. 2 is a structural schematic view illustrating a permanent magnet motor rotor of the permanent magnet synchronous motor as shown in FIG. 1;

FIG. 3 is a structural schematic view illustrating the permanent magnet motor rotor as shown in FIG. 2, when it is rotating clockwise;

FIG. 4 is a structural schematic view illustrating the permanent magnet motor rotor as shown in FIG. 2, when it is rotating anticlockwise;

FIG. 5 is a structural schematic view illustrating the permanent magnet motor rotor as shown in FIG. 2, wherein the main-pole permanent magnet and the auxiliary permanent magnet of the rotor are assembled together;

Wherein:

100—permanent magnet synchronous motor;

110—permanent magnet motor rotor; 111—rotor core;

112—main-pole permanent magnet; 113—auxiliary permanent magnet;

120—stator; 121—stator core; 122—stator winding.

### DETAILED DESCRIPTION OF DISCLOSED EMBODIMENTS

In order to make the objectives, the technical schemes and the benefits of the present disclosure to be more apparent, a permanent magnet motor rotor and a permanent magnet synchronous motor of the present disclosure will be described in more details through the following embodiments with reference to the accompanying figures. It should be understood that the embodiments described herein is only for explaining the present disclosure, but not for limiting the present disclosure.

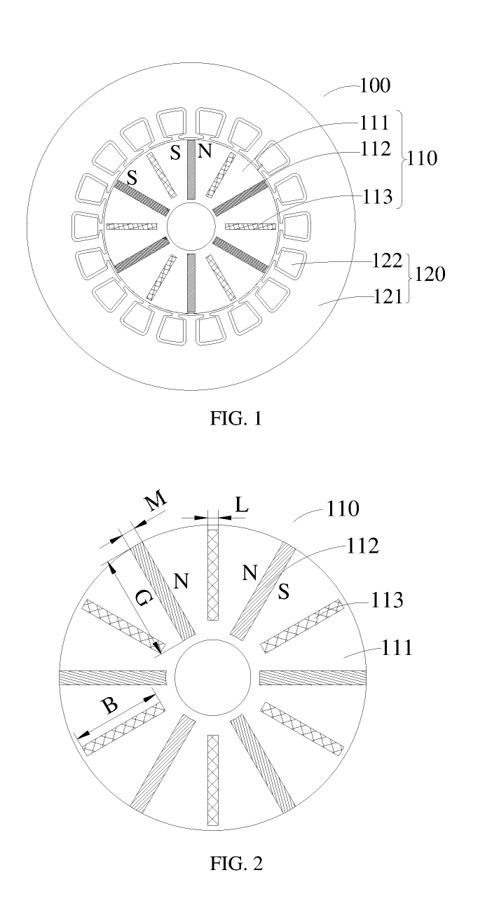

Referring to FIG. 1, according to one embodiment of the present invention, a permanent magnet motor rotor 110 includes a rotor core 111, tangentially magnetized main-pole permanent magnets 112 and tangentially magnetized auxiliary permanent magnets 113. An even number of receiving grooves are disposed in the rotor core 111, and the even number of the receiving grooves are arranged uniformly in a circumferential direction of the rotor core 111, and each receiving groove is disposed in a radial direction of the rotor core 111. The number of the receiving grooves is equal to the number of the poles of the permanent magnet synchronous motor, and the number of the main-pole permanent magnets is equal to the number of the receiving grooves. That is, the permanent magnet synchronous motor 100 has an even number of poles, and the number of main-pole permanent magnets is an even number, and the even number of main-pole permanent magnets 112 are distributed uniformly in the circumferential direction of the rotor core 111. Each main-pole permanent magnet 112 is disposed in a receiving groove respectively, and the closest surfaces of any two adjacent main-pole permanent magnets 112 have same magnetic poles. Each receiving groove receives a main-pole permanent magnet 112, so that both surfaces of the main-pole permanent magnet 112 are able to provide air-gap magnetic flux, which increases the air-gap magnetic flux of the permanent magnet synchronous motor 100, and improves the utilization rate of the air-gap magnetic flux.

Meanwhile, the closest surfaces of any two adjacent main-pole permanent magnets 112 have same magnetic poles, that is, an N-pole of one main-pole permanent magnet 112 faces an N-pole of another adjacent main-pole permanent magnet 112, and an S-pole of one main-pole permanent magnet 112 faces an S-pole of the other adjacent main-pole permanent magnet 112, which ensures that the number of the poles of the permanent magnet synchronous motor 100 is equal to the number of the main-pole permanent magnets 112. By respectively installing an even number of main-pole permanent magnets 112 into the receiving grooves arranged uniformly, it is ensured that the magnetic repulsion force on the main-pole permanent magnet 112 is balanced, and the number of the poles of the permanent magnet synchronous motor 100 is equal to the number of the main-pole permanent magnets 112.

The auxiliary permanent magnet 113 is located between any two adjacent main-pole permanent magnets 112, and the auxiliary permanent magnet 113 is arranged in a radial direction of the rotor core 111. In this embodiment, the number of the auxiliary permanent magnets 113 is equal to the number of the main-pole permanent magnets 112, meanwhile one auxiliary permanent magnet 113 is provided between every two adjacent main-pole permanent magnets 112. The main-pole permanent magnets 112 and the auxiliary permanent magnets 113 are tangentially magnetized, so that the permanent magnet synchronous motor 100 can generate a higher air-gap magnetic flux, and have a higher ratio of the torque to the current and a higher ratio of the torque to the volume. The main-pole permanent magnets 112 and the auxiliary permanent magnets 113 are placed along the radial direction of the rotor core 111, and by arranging a tangentially magnetized auxiliary permanent magnet 113 between any two adjacent main-pole permanent magnets 112, a part of the magnetic lines of the main-pole permanent magnet 112 connect with the magnetic lines of the auxiliary permanent magnet 113 in series, and then enter into the air-gap, thus the operating point of the main-pole permanent magnet 112 is remarkably raised, and the permanent magnet motor rotor 110 generates more flux linkage at the side of the stator 120, thereby the utilization rate of the air-gap magnetic flux is increased, and the output torque and the efficiency of the permanent magnet synchronous motor 100 are improved.

Since both surfaces of a single permanent magnet in the existing tangential permanent magnet motor are configured to provide air-gap magnetic flux simultaneously, the magnetic circuit has a parallel structure, so that the tangentially magnetized permanent magnet motor has a lower operating point as compared with the radially magnetized permanent magnet motor, which may be prone to decrease the efficiency of the tangentially magnetized permanent magnet motor. Even more, there is a risk of demagnetization of the tangentially magnetized permanent magnet motor, which may result in that the tangential permanent magnet motor is unable to operate. According to the present disclosure, an auxiliary permanent magnet 113 is installed between any two main-pole permanent magnets 112 in the permanent magnet motor rotor, a part of the magnetic lines of the main-pole permanent magnet 112 connect with the magnetic lines of the auxiliary permanent magnet 113 in series, and then enter into the air-gap, thus the operating point of the main-pole permanent magnet 112 is remarkably raised, and the output torque of the permanent magnet synchronous motor 100 is increased. Meanwhile, because of the increase of the operating point of the main-pole permanent magnet 112, the demagnetization resistance capacity of the main-pole permanent magnet 112 is improved, and the demagnetization risk of the permanent magnet synchronous motor 100 under rugged environment is reduced.

Referring to FIG. 2 to FIG. 5, in one embodiment, the number of the main-pole permanent magnets 112 is great than or equal to four. With no less than four main-pole permanent magnets 112, the permanent magnet synchronous motor 100 can have a better magnetic congregate effect and a higher output torque. In this embodiment, there are six main-pole permanent magnets 112, and the six main-pole permanent magnets 112 are arranged in such a manner that an N-pole of one main-pole permanent magnet 112 faces an N-pole of an adjacent main-pole permanent magnet 112, an S-pole of one main-pole permanent magnet 112 faces an S-pole of the other adjacent main-pole permanent magnet 112. The auxiliary permanent magnet 113 is located between any two main-pole permanent magnets 112, the N-pole of the auxiliary permanent magnet 113 faces the N-pole of one adjacent main-pole permanent magnet 112, and the S-pole of the auxiliary permanent magnet 113 faces the S-pole of the other adjacent main-pole permanent magnet 112.

In one embodiment, the auxiliary permanent magnet 113 is located at a symmetrical centerline between any two adjacent main-pole permanent magnets 112. The auxiliary permanent magnet 113 is different from the main-pole permanent magnet 112, although the auxiliary permanent magnet 113 is also tangentially magnetized, the number of the poles of the permanent magnet synchronous motor 100 increases with the increase of the number of the main-pole permanent magnets 112, but the increase of the number of the auxiliary permanent magnets 113 will not influence the number of the poles of the permanent magnet synchronous motor 100, and only help in the efficiency and the demagnetization of the permanent magnet synchronous motor 100. When the auxiliary permanent magnet 113 is located at a symmetrical centerline between any two main-pole permanent magnets 112, the efficiency of the permanent magnet synchronous motor 100 is remarkably improved and the demagnetization effect is apparent.

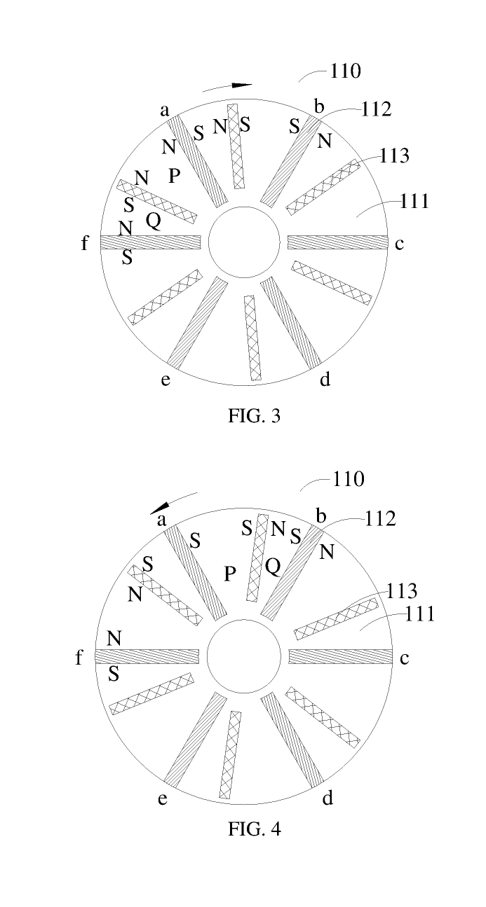

Furthermore, the auxiliary permanent magnet 113 may be disposed at a position offset from the symmetrical centerline between any two main-pole permanent magnets 112, and the auxiliary permanent magnet 113 is offset toward the adjacent main-pole permanent magnet 112 having an opposite magnetic pole from that of the auxiliary permanent magnet 113. Researches show that, the magnetic lines of the permanent magnet motor rotor 110 mainly concentrate in a section formed by the surface of the auxiliary permanent magnet 113 and the opposite surface of the adjacent main-pole permanent magnet 112 having the same magnetic pole as the surface of the auxiliary permanent magnet 113, for example, as shown in FIG. 3, the section denoted as section P at the front side of the main-pole permanent magnet 112 contains more magnetic lines, while the section, which is formed by the surface of the auxiliary permanent magnet 113 and the opposite surface of the adjacent main-pole permanent magnet 112 having the opposite magnetic pole from the surface of the auxiliary permanent magnet 113, contains less magnetic lines, that is, the section denoted as section Q at the rear side of the main-pole permanent magnet 112 contains less magnetic lines. By placing the auxiliary permanent magnet 113 at a position offset from the symmetrical centerline between any two main-pole permanent magnets 112, and offsetting the auxiliary permanent magnet 113 toward the tangentially magnetized permanent magnet having an opposite magnetic pole from that of auxiliary permanent magnet 113, the area of the section P containing more magnetic lines can be increased, and the permanent magnet motor rotor 110 can generate more air-gap magnetic flux, so that the output torque of unit current of the permanent magnet synchronous motor 100 can be improved. And a better effect will be obtained by placing the section containing more magnetic lines at the front side in a rotation direction of the permanent magnet motor rotor 110.

In one embodiment, the coercivity of the auxiliary permanent magnet 113 is less than that of the main-pole permanent magnet 112. Researches show that, the operating point of the auxiliary permanent magnet 113 is always higher than that of the main-pole permanent magnet 112, as a result, the demagnetization resistance capacity of the auxiliary permanent magnet 113 is not in accordance with that of the main-pole permanent magnet 112, thus decreasing the demagnetization resistance capacity of the permanent magnet motor rotor 110. By means of setting the coercivity of the auxiliary permanent magnet 113 less than the coercivity of the main-pole permanent magnet 112, the operating point of the auxiliary permanent magnet 113 may be approximate to the operating point of the main-pole permanent magnet 112, so that the overall demagnetization resistance capacity of the permanent magnet synchronous motor 100 can be improved. Alternatively, by setting the width L of the auxiliary permanent magnet 113 in the circumferential direction of the rotator core 111 being less than the width M of the main-pole permanent magnet 112 in the circumferential direction of the rotator core 111, the operating points of the auxiliary permanent magnet 113 can be approximate to the operating point of the main-pole permanent magnet 112, so that the overall demagnetization resistance capacity of the permanent magnet synchronous motor 100 can be improved.

In one embodiment, the length B of the auxiliary permanent magnet 113 in a radical direction of the rotor core 111 is less than the length G of the main-pole permanent magnet 112 in the radical direction of the rotor core 111. When the permanent magnet synchronous motor 100 is in operation, a part of the magnetic lines of the main-pole permanent magnet 112 connect with the magnetic lines of the auxiliary permanent magnet 113 in series, and then enter into the air-gap, another part of the magnetic lines of the main-pole permanent magnet 112 enter into the air-gap from the end of the auxiliary permanent magnet 113 located at the front side of the main-pole permanent magnet 112 along the rotation direction. By setting the length B of the auxiliary permanent magnet 113 in the radical direction of the rotor core 111 being less than the length G of the main-pole permanent magnet 112 in the radical direction of the rotor core 111, the magnetic flux of another part of the magnetic lines will not decrease due to the magnetic saturation.

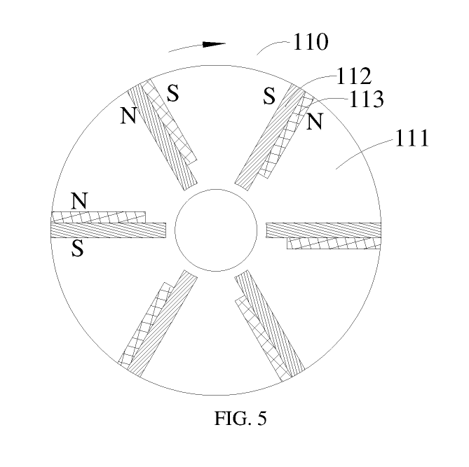

In one embodiment, any pair of adjacent main-pole permanent magnet 112 and auxiliary permanent magnet 113 are arranged in parallel, and the surface of the main-pole permanent magnet 112 is attached to the surface of the auxiliary permanent magnet 113 having an opposite magnetic pole from that of the main-pole permanent magnet 112. The magnetic pole of the main-pole permanent magnet 112 is the same as that of the auxiliary permanent magnet 113, so as to enlarge the area of the section containing more magnetic lines, and to improve the efficiency of the permanent magnet synchronous motor 100. The rotation direction of the permanent magnet motor rotor 110 is along the direction from the side of the main-pole permanent magnet 112 towards the auxiliary permanent magnet 113 attached with the main-pole permanent magnet 112, that is, the permanent magnet motor rotor 110 rotates along the direction from the rear side to the front side of the main-pole permanent magnet 112. Taking the main-pole permanent magnet 112 located at the position a as an example, the arrow direction shown in FIG. 5 is the rotation direction of the rotor core 111, the pole at the front side of the main-pole permanent magnet 112 is an S-pole, and the pole at the rear side of the main-pole permanent magnet 112 is an N-pole, while the auxiliary permanent magnet 113 at the front side of the main-pole permanent magnet 112 has an S-pole and an N-pole respectively. Meanwhile, the N-pole of the main-pole permanent magnet 112 is attached to the S-pole of the auxiliary permanent magnet 113, therefore the permanent magnet pair located at the position a has an N-pole at the front side and has an S-pole at the rear side. Of course, in order to further enlarge the area of the section containing more magnetic lines, and to improve the efficiency of the permanent magnet synchronous motor 100, any pair of adjacent main-pole permanent magnet 112 and auxiliary permanent magnet 113 can be assembled together. And in order to simplify the manufacturing process, the main-pole permanent magnet 112 and the auxiliary permanent magnet 113 can be integrated in one piece.

Referring to FIG. 1, according to one embodiment of the present invention, the permanent magnet synchronous motor 100 includes a stator and a rotor, and the rotor is the permanent magnet motor rotor 110 described in any aforementioned embodiments. Specifically, the permanent magnet synchronous motor 100 includes at least a permanent magnet motor rotor 110 and a stator 120 disposed outside the permanent magnet motor rotor 110, the permanent magnet motor rotor 110 includes main-pole permanent magnets 112 and auxiliary permanent magnets 113. The stator 120 includes a stator core 121 and stator windings 122, the stator windings 122 are installed on the stator core 121. By arranging the auxiliary permanent magnet 113 between any two adjacent main-pole permanent magnets 112, the operating point of the main-pole permanent magnet 112 is remarkably raised, and more flux linkage can be generated by the permanent magnet motor rotor 110 at the stator 120 side, the utilization rate of the air-gap magnetic flux can be improved, and the output torque of the permanent magnet synchronous motor 100 is improved. And because to the increase of the operating point of the main-pole permanent magnet 112, the demagnetization resistance capacity of the main-pole permanent magnet 112 is improved, and the demagnetization risk of the permanent magnet synchronous motor 100 under rugged environment is reduced.

What described above are only some embodiments of the present invention, which is more specific and detailed, it will be understood that they are not intended to limit to these embodiments. It should be understood by those skilled in the art that various modifications and replacements may be made therein without departing from the theory of the present disclosure, which should also be seen in the scope of the present disclosure. The scope of the present disclosure should be defined by the appended claims.

The embodiments of the invention in which an exclusive property or privilege is claimed are defined as follows:

1. A permanent magnet motor rotor, comprising:
a rotor core (111);
tangentially magnetized main-pole permanent magnets (112), the main-pole permanent magnets (112) being disposed in a radial direction of the rotor core (111), number of the main-pole permanent magnets (112) being equal to number of poles of a permanent magnet synchronous motor, the main-pole permanent magnets (112) being uniformly arranged in a circumferential direction of the rotor core (111), and closest surfaces of any two adjacent main-pole permanent magnets (112) having same magnetic pole; and
a tangentially magnetized auxiliary permanent magnet (113), the auxiliary permanent magnet (113) being disposed in the radial direction of the rotor core (111), and the auxiliary permanent magnet (113) being located between any two adjacent main-pole permanent magnets (112).

2. The permanent magnet motor rotor of claim 1, wherein the auxiliary permanent magnet (113) is located at a symmetrical centerline between any two adjacent main-pole permanent magnets (112).

3. The permanent magnet motor rotor of claim 1, wherein the auxiliary permanent magnet (113) is located at a position offset from a symmetrical centerline between any two main-pole permanent magnets (112), and the auxiliary permanent magnet (113) is offset toward an adjacent main-pole permanent magnet (112) having an opposite magnetic pole from that of the auxiliary permanent magnet (113).

4. The permanent magnet motor rotor of claim 1, wherein coercivity of the auxiliary permanent magnet (113) is less than coercivity of the main-pole permanent magnet (112).

5. The permanent magnet motor rotor of claim 1, wherein a width of the auxiliary permanent magnet (113) in a circumferential direction of the rotor core (111) is less than a width of the main-pole permanent magnet (112) in a circumferential direction of the rotor core (111).

6. The permanent magnet motor rotor of claim 1, wherein a length of the auxiliary permanent magnet (113) in a radial direction of the rotor core (111) is less than a length of the main-pole permanent magnet (112) in a radial direction of the rotor core (111).

7. The permanent magnet motor rotor of claim 1, wherein the number of the main-pole permanent magnets (112) is larger than or equal to four.

8. The permanent magnet motor rotor of claim 1, wherein any pair of adjacent main-pole permanent magnet (112) and auxiliary permanent magnet (113) are arranged in parallel, and surface of the main-pole permanent magnet (112) is attached to surface of the auxiliary permanent magnet (113) having an opposite magnetic pole from that of the main-pole permanent magnet (112).

9. The permanent magnet motor rotor of claim 8, wherein any pair of adjacent main-pole permanent magnet (112) and auxiliary permanent magnet (113) are integrated.

10. A permanent magnet synchronous motor, comprising a stator and a rotor, the stator being disposed outside the rotor, wherein, the rotor is defined as the permanent magnet motor rotor (110) in claim 1.

11. The permanent magnet synchronous motor of claim 10, wherein the auxiliary permanent magnet (113) is located at a symmetrical centerline between any two adjacent main-pole permanent magnets (112).

12. The permanent magnet synchronous motor of claim 10, wherein the auxiliary permanent magnet (113) is located at a position offset from a symmetrical centerline between any two main-pole permanent magnets (112), and the auxiliary permanent magnet (113) is offset toward an adjacent main-pole permanent magnet (112) having an opposite magnetic pole from that of the auxiliary permanent magnet (113).

13. The permanent magnet synchronous motor of claim 10, wherein coercivity of the auxiliary permanent magnet (113) is less than coercivity of the main-pole permanent magnet (112).

14. The permanent magnet synchronous motor of claim 10, wherein a width of the auxiliary permanent magnet (113) in a circumferential direction of the rotor core (111) is less than a width of the main-pole permanent magnet (112) in a circumferential direction of the rotor core (111).

15. The permanent magnet synchronous motor of claim 10, wherein a length of the auxiliary permanent magnet (113) in a radial direction of the rotor core (111) is less than a length of the main-pole permanent magnet (112) in a radial direction of the rotor core (111).

16. The permanent magnet synchronous motor of claim 10, wherein the number of the main-pole permanent magnets (112) is larger than or equal to four.

17. The permanent magnet synchronous motor of claim 10, wherein any pair of adjacent main-pole permanent magnet (112) and auxiliary permanent magnet (113) are arranged in parallel, and surface of the main-pole permanent magnet (112) is attached to surface of the auxiliary permanent magnet (113) having an opposite magnetic pole from that of the main-pole permanent magnet (112).

18. The permanent magnet synchronous motor of claim 10, wherein any pair of adjacent main-pole permanent magnet (112) and auxiliary permanent magnet (113) are integrated.
